(19) United States
(12) Patent Application Publication
(10) Pub. No.: US 2023/0044482 A1
(43) Pub. Date: Feb. 9, 2023

(54) EXPANDABLE PERSONALIZED TRAVEL DASHBOARD

(71) Applicant: Albert Hallivis, Olney, MD (US)

(72) Inventor: Albert Hallivis, Olney, MD (US)

(21) Appl. No.: 17/711,674

(22) Filed: Apr. 1, 2022

Related U.S. Application Data
(60) Provisional application No. 63/144,393, filed on Feb. 1, 2021.

(51) Int. Cl. G06Q 50/14

(52) U.S. Cl. CPC G06Q 50/14; G06F 3/0482

(57) ABSTRACT

A system and method for assisting an individual to plan a trip, and the system can act as a travel companion to guide the individual on the trip. The system includes an AI module that can learn travel preferences of the individual. An aggregation module can get travel-related data from third party servers and databases and uses an AI model generated by the AI module to analyze the data, presenting relevant information to the individual. A planning module can act as a travel companion by knowing current location of the individual and present timely information to the individual.

### CROSS-REFERENCE TO RELATED APPLICATIONS

This application claims priority from the U.S. Provisional Patent Appl. Ser. No. 63/144,393, filed on Feb. 1, 2021, which is incorporated herein by reference in its entirety.

### FIELD OF INVENTION

The present invention relates to a system and method for travel assistance, and more particularly, the present invention relates to a system, method, and dashboard for organizing and presenting travel information using artificial intelligence.

### BACKGROUND

People travel to various places for a variety of reasons, such as educational, recreational, business, religious, and the like. Recreational travel refers to travel for pleasure and recreation. While in other reasons for travel such as business trips or religious trips, the destination is known, however, for recreational travel, people often like to visit unfamiliar places. While planning a trip for whatsoever purpose, a lot of factors kicks in, such as where to travel when the destination is not known, stay, transport, travel itinerary, and the like. Persons may depend on a variety of sources for information, such as suggestions from friends and relatives, expert advice from the tour and travel operators, websites, blogs, reviews, and the like. Although the information is available but is scattered, it becomes tedious and time-consuming to plan a trip.

Once a trip is planned, then the execution of the trip may involve a range of steps, such as booking the transport and stays, arranging maps, and the like. The different tasks can make the process complex and hectic for many people. Moreover, certain information such as destination, timings, and the like may also have to be written down. People must remember the dates and times of catching the flights, and the like.

Thus, a need is appreciated for a personalized travel dashboard that can assist people with planning and executing a trip, automating many of the aforesaid tasks. A need is appreciated for an artificial intelligence-based system and method that may act as a travel companion.

### SUMMARY OF THE INVENTION

The following presents a simplified summary of one or more embodiments of the present invention to provide a basic understanding of such embodiments. This summary is not an extensive overview of all contemplated embodiments and is intended to neither identify critical elements of all embodiments nor delineate the scope of any or all embodiments. Its sole purpose is to present some concepts of one or more embodiments in a simplified form as a prelude to the more detailed description that is presented later.

The principal object of the present invention is therefore directed to a system and method that can act as a travel companion to guide a traveler on a trip.

It is another object of the present invention that the system can present only relevant information to the user.

It is another object of the present invention that information related to the trip is readily accessible.

It is still another object of the present invention that the user does not have to write down valuable information related to travel.

It is an additional object of the present invention that the tedious job of planning a trip is made easy.

It is a further object of the present invention that any important information is communicated to the user on time.

In one aspect, disclosed is a system and method for guiding an individual on a trip, the method implemented within the system, the system comprising a processor and memory, the method comprising the steps of: learning, by an AI module implemented within the system and upon execution by the processor, travel-related preferences of a user; extracting, by an aggregation module implemented within the system and upon execution by the processor, travel-related data not hosted on the system; determining, by the aggregation module, from the travel-related, relevant information based on the travel-related preferences; and presenting, by a planning module implemented within the system and upon execution by the processor, the relevant information on a user device.

In one implementation, the method further comprises the steps of determining, by the planning module, a current location of the user device; and presenting, by the planning module, a portion of the relevant information that is related to the current location.

In one implementation, the method further comprises the steps of presenting, by an interface module implemented within the system and upon execution by the processor, a list of travel-related categories on the user device, wherein each category of the list of travel-related categories comprises a plurality of related applications; receiving, by the interface module, a selection of a predetermined number of related applications from the plurality of related applications in the each category; and presenting, by the interface module, the selected applications category-wise.

In one implementation, the method further comprises the steps of tracking usage of application on the user device; and presenting, by the interface module, a screen that has a list of frequently used applications based on the usage.

In one implementation, the method further comprises the steps of presenting, by an interface module implemented within the system and upon execution by the processor, an overlay screen on the user device, wherein the portion of the relevant information is presented on the overlay screen, wherein the overlay screen is configured to switch between a visible and inactive state and a visible and active state

### BRIEF DESCRIPTION OF THE DRAWINGS

The accompanying figures, which are incorporated herein, form part of the specification and illustrate embodiments of the present invention. Together with the description, the figures further explain the principles of the present invention and enable a person skilled in the relevant arts to make and use the invention

FIG. 1 is a block diagram showing the architecture of the disclosed system, according to an exemplary embodiment of the present invention.

FIG. 2 shows an implementation of the interface, which is a login screen, generated by the interface module, according to an exemplary embodiment of the present invention.

FIG. 3 shows another implementation of the interface, which is the artificial intelligence (AI) top screen, according to an exemplary embodiment of the present invention.

FIG. 4 shows another implementation of the interface, which is a personal travel information screen, according to an exemplary embodiment of the present invention.

FIG. 5 shows another implementation of the interface, which is a travel category screen, according to an exemplary embodiment of the present invention.

FIG. 6 illustrates another screen of the travel category screen of FIG. 5, according to an exemplary embodiment of the present invention.

FIG. 7 shows another implementation of the interface, which is a miscellaneous resources screen, according to an exemplary embodiment of the present invention.

FIG. 8 shows another implementation of the interface, which is a trip expenses screen, according to an exemplary embodiment of the present invention.

FIG. 9 shows another implementation of the interface, which is a dashboard screen, according to an exemplary embodiment of the present invention.

FIG. 10 shows another implementation of the interface, which is an entertainment screen, according to an exemplary embodiment of the present invention.

FIG. 11 shows another implementation of the interface, which is a local information screen, according to an exemplary embodiment of the present invention.

FIG. 12 shows another implementation of the interface, which is an indexing screen for heath information and business information, according to an exemplary embodiment of the present invention.

FIG. 13 shows another implementation of the interface, which is a control panel screen, according to an exemplary embodiment of the present invention.

FIG. 14 shows another implementation of the interface, which is a favorite apps screen, according to an exemplary embodiment of the present invention.

FIG. 15 shows another implementation of the interface, which is a favorite apps screen, according to an exemplary embodiment of the present invention.

FIG. 16 is a flow chart illustrating steps in customization of the disclosed application, according to an exemplary embodiment of the present invention.

FIG. 17 is a flow chart illustrating an aspect of the system, according to an exemplary embodiment of the present invention.

FIG. 18 is a flowchart illustrating major travel intervals, according to an exemplary embodiment of the present invention.

FIGS. 19A and 19B show an overlay screen presented to the user providing a summary of a trip, according to an exemplary embodiment of the present invention.

### DETAILED DESCRIPTION

Subject matter will now be described more fully hereinafter with reference to the accompanying drawings, which form a part hereof, and which show, by way of illustration, specific exemplary embodiments. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, the reasonably broad scope for claimed or covered subject matter is intended. Among other things, for example, the subject matter may be embodied as methods, devices, components, or systems. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage, or mode of operation.

The terminology used herein is to describe particular embodiments only and is not intended to be limiting to embodiments of the invention. As used herein, the singular forms “a”, “an”, and “the” are intended to include the plural forms as well, unless the context indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely to illustrate the general principles of the invention since the scope of the invention will be best defined by the allowed claims of any resulting patent.

The present invention is best understood by reference to the detailed figures and description set forth herein.

A “computer” may refer to one or more apparatus and/or one or more systems that are capable of accepting a structured input, processing the structured input according to prescribed rules, and producing results of the processing as output. Examples of a computer may include: a computer; a stationary and/or portable computer; a computer having a single processor, multiple processors, or multi-core processors, which may operate in parallel and/or not in parallel; a general purpose computer; a supercomputer; a mainframe; a super mini-computer; a mini-computer; a workstation; a micro-computer; a server; a client; an interactive television; a web appliance; a telecommunications device with internet access; a hybrid combination of a computer and an interactive television; a portable computer; a tablet personal computer (PC); a personal digital assistant (PDA); a portable telephone; application-specific hardware to emulate a computer and/or software, such as, for example, a digital signal processor (DSP), a field-programmable gate array (FPGA), an application specific integrated circuit (ASIC), an application specific instruction-set processor (ASIP), a chip, chips, a system on a chip, or a chip set; a data acquisition device; an optical computer; a quantum computer; a biological computer; and generally, an apparatus that may accept data, process data according to one or more stored software programs, generate results, and typically include input, output, storage, arithmetic, logic, and control units.

Those of skill in the art will appreciate that where appropriate, some embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Where appropriate, embodiments may also be practiced in distributed computing environments where tasks are performed by local and remote processing devices that are linked (either by hardwired links, wireless links or a combination thereof) through a communications network. In a distributed computing environment, program modules may be located in both local and remote memory storage devices.

“Software” may refer to prescribed rules to operate a computer. Examples of software may include code segments in one or more computer-readable languages; graphical and or/textual instructions; applets; pre-compiled code; interpreted code; compiled code; and computer programs.

While embodiments herein may be discussed in terms of a processor having a certain number of bit instructions/data, those skilled in the art will know others that may be suitable such as 16 bits, 32 bits, 64 bits, 128 bit, or 256-bit processors or processing, which can usually alternatively be used. Where a specified logical sense is used, the opposite logical sense is also intended to be encompassed.

The example embodiments described herein can be implemented in an operating environment comprising computer-executable instructions (e.g., software) installed on a computer, in hardware, or a combination of software and hardware. The computer-executable instructions can be written in a computer programming language or can be embodied in firmware logic. If written in a programming language conforming to a recognized standard, such instructions can be executed on a variety of hardware platforms and for interfaces to a variety of operating systems. Although not limited thereto, computer software program code for carrying out operations for aspects of the present invention can be written in any combination of one or more suitable programming languages, including object-oriented programming languages and/or conventional procedural programming languages, and/or programming languages such as, for example, Hypertext Markup Language (HTML), Dynamic HTML, Extensible Markup Language (XML), Extensible Stylesheet Language (XSL), Document Style Semantics and Specification Language (DSSSL), Cascading Style Sheets (CSS), Synchronized Multimedia Integration Language (SMIL), Wireless Markup Language (WML), Java™, Jini™, C, C++, Smalltalk, Perl, UNIX Shell, Visual Basic or Visual Basic Script, Virtual Reality Markup Language (VRML), ColdFusion™, or other compilers, assemblers, interpreters or other computer languages or platforms.

Computer program code for carrying out operations for aspects of the present invention may be written in any combination of one or more programming languages, including an object-oriented programming language such as Java, Smalltalk, C++, or the like, and conventional procedural programming languages, such as the “C” programming language or similar programming languages. The program code may execute entirely on the user's computer, partly on the user's computer, as a stand-alone software package, partly on the user's computer, partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

A network is a collection of links and nodes (e.g., multiple computers and/or other devices connected together) arranged so that information may be passed from one part of the network to another over multiple links and through various nodes. Examples of networks include the Internet, the public switched telephone network, the global Telex network, computer networks (e.g., an intranet, an extranet, a local-area network, or a wide-area network), wired networks, and wireless networks.

The Internet is a worldwide network of computers and computer networks arranged to allow the easy and robust exchange of information between computer users. Hundreds of millions of people around the world have access to computers connected to the Internet via Internet Service Providers (ISPs). Content providers (e.g., website owners or operators) place multimedia information (e.g., text, graphics, audio, video, animation, and other forms of data) at specific locations on the Internet referred to as webpages. Websites comprise a collection of connected or otherwise related, webpages. The combination of all the websites and their corresponding web pages on the Internet is generally known as the World Wide Web (WWW) or simply the Web.

Aspects of the present invention are described below with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The flowchart and block diagrams in the Figures illustrate the architecture, functionality, and operation of implementations of systems, methods, and computer program products according to various embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

These computer program instructions may also be stored in a computer-readable medium that can direct a computer, other programmable data processing apparatus, or other devices to function in a particular manner, such that the instructions stored in the computer-readable medium produce an article of manufacture including instructions which implement the function/act specified in the flowchart and/or block diagram block or blocks.

Further, although process steps, method steps, algorithms, or the like may be described in sequential order, such processes, methods, and algorithms may be configured to work in alternate orders. In other words, any sequence or order of steps that may be described does not necessarily indicate a requirement that the steps be performed in that order. The steps of processes described herein may be performed in any order practical. Further, some steps may be performed simultaneously.

It will be readily apparent that the various methods and algorithms described herein may be implemented by, e.g., appropriately programmed general-purpose computers and computing devices. Typically, a processor (e.g., a microprocessor) will receive instructions from a memory or like device, and execute those instructions, thereby performing a process defined by those instructions. Further, programs that implement such methods and algorithms may be stored and transmitted using a variety of known media.

When a single device or article is described herein, it will be readily apparent that more than one device/article (whether they cooperate) may be used in place of a single device/article. Similarly, where more than one device or article is described herein (whether or not they cooperate), it will be readily apparent that a single device/article may be used in place of more than one device or article.

The functionality and/or the features of a device may be alternatively embodied by one or more other devices which are not explicitly described as having such functionality/features. Thus, other embodiments of the present invention need not include the device itself.

The term “computer-readable medium” as used herein refers to any medium that participates in providing data (e.g., instructions) that may be read by a computer, a processor, or a like device. Such a medium may take many forms, including but not limited to, non-volatile media, volatile media, and transmission media. Non-volatile media include, for example, optical or magnetic disks and other persistent memory. Volatile media include dynamic random-access memory (DRAM), which typically constitutes the main memory. Transmission media include coaxial cables, copper wire, and fiber optics, including the wires that comprise a system bus coupled to the processor. Transmission media may include or convey acoustic waves, light waves, and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, removable media, flash memory, a “memory stick”, any other memory chip or cartridge, a carrier wave as described hereinafter, or any other medium from which a computer can read.

Various forms of computer-readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards, or protocols, such as Bluetooth, TDMA, CDMA, 3G, 4G, and 5G.

Where databases are described, it will be understood by one of ordinary skill in the art that (i) alternative database structures to those described may be readily employed, and (ii) other memory structures besides databases may be readily employed. Any schematic illustrations and accompanying descriptions of any sample databases presented herein are exemplary arrangements for stored representations of information. Any number of other arrangements may be employed besides those suggested by the tables shown. Similarly, any illustrated entries of the databases represent exemplary information only; those skilled in the art will understand that the number and content of the entries can be different from those illustrated herein. Further, despite any depiction of the databases as tables, an object-based model could be used to store and manipulate the data types of the present invention and likewise, object methods or behaviors can be used to implement the processes of the present invention.

A “computer system” may refer to a system having one or more computers, where each computer may include a computer-readable medium embodying software to operate the computer or one or more of its components. Examples of a computer system may include: a distributed computer system for processing information via computer systems linked by a network; two or more computer systems connected via a network for transmitting and/or receiving information between the computer systems; a computer system including two or more processors within a single computer; and one or more apparatuses and/or one or more systems that may accept data, may process data in accordance with one or more stored software programs, may generate results, and typically may include input, output, storage, arithmetic, logic, and control units.

A “network” may refer to several computers and associated devices that may be connected by communication facilities. A network may involve permanent connections such as cables or temporary connections such as those made through telephone or other communication links. A network may further include hard-wired connections (e.g., coaxial cable, twisted pair, optical fiber, waveguides, etc.) and/or wireless connections (e.g., radiofrequency waveforms, free-space optical waveforms, acoustic waveforms, etc.). Examples of a network may include internet, such as the Internet; an intranet; a local area network (LAN); a wide area network (WAN); and a combination of networks, such as an internet and an intranet.

As used herein, the “client-side” application should be broadly construed to refer to an application, a page associated with that application, or some other resource or function invoked by a client-side request to the application. A “browser” as used herein is not intended to refer to any specific browser (e.g., Internet Explorer, Safari, Firefox, or the like), but should be broadly construed to refer to any client-side rendering engine that can access and display Internet-accessible resources. A “rich” client typically refers to a non-HTTP-based client-side application, such as an SSH or CFIS client. Further, while typically the client-server interactions occur using HTTP, this is not a limitation either. The client-server interaction may be formatted to conform to the Simple Object Access Protocol (SOAP) and travel over HTTP (over the public Internet), FTP or any other reliable transport mechanism (such as IBM® MQSeries® technologies and CORBA, for transport over an enterprise intranet) may be used. Any application or functionality described herein may be implemented as native code, by providing hooks into another application, facilitating the use of the mechanism as a plug-in, linking to the mechanism, and the like.

Exemplary networks may operate with any of a number of protocols, such as Internet protocol (IP), asynchronous transfer mode (ATM), and/or synchronous optical network (SONET), user datagram protocol (UDP), IEEE 802x, etc.

Embodiments of the present invention may include apparatuses for performing the operations disclosed herein. An apparatus may be specially constructed for the desired purposes, or it may comprise a general-purpose device selectively activated or reconfigured by a program stored in the device.

Embodiments of the invention may also be implemented in one or a combination of hardware, firmware, and software. They may be implemented as instructions stored on a machine-readable medium, which may be read and executed by a computing platform to perform the operations described herein.

More specifically, as will be appreciated by one skilled in the art, aspects of the present invention may be embodied as a system, method, or computer program product.

Accordingly, aspects of the present invention may take the form of an entirely hardware embodiment, an entire software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

In the following description and claims, the terms “computer program medium” and “computer readable medium” may be used to generally refer to media such as, but not limited to, removable storage drives, a hard disk installed in hard disk drive, and the like. These computer program products may provide software to a computer system. Embodiments of the invention may be directed to such computer program products.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, and as may be apparent from the following description and claims, it should be appreciated that throughout the specification descriptions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Additionally, the phrase “configured to” or “operable for” can include generic structure (e.g., generic circuitry) that is manipulated by software and/or firmware (e.g., an FPGA or a general-purpose processor executing software) to operate in a manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks.

In a similar manner, the term “processor” may refer to any device or portion of a device that processes electronic data from registers and/or memory to transform that electronic data into other electronic data that may be stored in registers and/or memory. A “computing platform” may comprise one or more processors.

Embodiments within the scope of the present disclosure may also include tangible and/or non-transitory computer-readable storage media for carrying or having computer-executable instructions or data structures stored thereon. Such non-transitory computer-readable storage media can be any available media that can be accessed by a general purpose or special purpose computer, including the functional design of any special purpose processor as discussed above. By way of example, and not limitation, such non-transitory computer-readable media can include RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

While a non-transitory computer readable medium includes, but is not limited to, a hard drive, compact disc, flash memory, volatile memory, random access memory, magnetic memory, optical memory, semiconductor-based memory, phase change memory, optical memory, periodically refreshed memory, and the like; the non-transitory computer readable medium, however, does not include a pure transitory signal per se; i.e., where the medium itself is transitory.

Disclosed is a system and method can assist people with their travel needs. Disclosed is a artificial intelligence based personalized travel dashboard that can provide personalized information to the user, thus making the process of planning a trip easier and comfortable. The disclosed system, method, and dashboard may act as a travel companion that can take care of different tasks while travelling. The disclosed system and method can be a smart aggregator of information that can learn the habits, requirements, and lifestyle, and like details of the user, and based on collected data can present personalized results to the user.

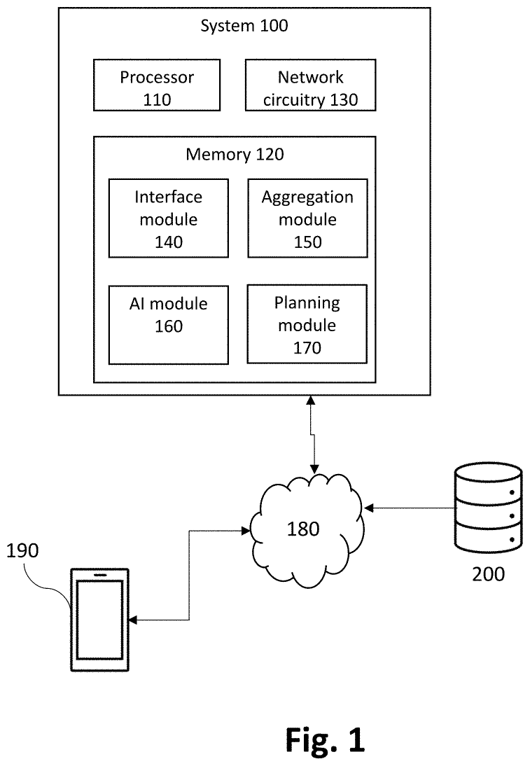

Referring to FIG. 1, which is a block diagram illustrating the architecture and environment of the disclosed system 100. The system 100 can include a processor 110 and a memory 120. The processor can be any logic circuitry that responds to, and processes instructions fetched from the memory. The memory may include one or more memory chips capable of storing data and allowing any storage location to be directly accessed by the processor. The memory includes modules according to the present invention for execution by the processor to perform one or more steps of the disclosed methodology. The modules can be software, program, code, or a set of instructions that upon executing by the processor perform one or more steps of the disclosed methodology. The system may also include a network circuitry 130 that may allow the disclosed system to connect to an external network 180. The network has been described previously in the detailed description. The disclosed system can connect to external databases 200 and user devices 190 through the network 180. The user device 190 can be a smartphone, tablet computer, laptop, desktop computer, and the like. While FIG. 1 shows a single user device, however, it is understood that more than one user device can connect with the disclosed system simultaneously or at various times. Moreover, for illustration herein, a single network is shown connecting the disclosed system to the user device and the database servers, it should be obvious to those reading this disclosure that external devices and servers can connect with the disclosed system through a different network, and a single device can connect with the disclosed system through a combination of networks, such as a combination of the wired and wireless network. A “user” as used herein, and throughout this disclosure, refers to an individual engaging a device according to embodiments of the invention wherein the engagement is a result of their personal use of the device or having another individual using the device upon them or in conjunction with their use of the device.

The disclosed system 100 can be implemented in an environment of servers which can be a single server or a group of servers. The group of servers can be at one location or geographically dispersed at distinct locations. The server includes cloud servers, and any other implementation of the servers, and all such implementations of the servers are within the scope of the present invention.

The memory can include an interface module 140, an aggregation module 150, an AI module 160, and a planning module 170. The interface module 140 upon execution by the processor can provide an interface for interacting with the disclosed system, presenting information to the user, and receiving input from the user. The interface can be provided as application software that can be installed on the user device. The application software can be developed for Android™, iOS™, and any other known operating platform for mobile devices. The application software can be made available through a distribution service provider, for example, Google Play™ operated and developed by Google, and the app store by Apple™. In addition to the application software, a website-based interface can also be provided through the world-wide-web. The application software can also be provided for the desktop environment, such as Windows™, Linux, and macOS™. The interface may permit interaction with a user through the user device, wherein information can be presented within the user interface by system 100 and information can be received by system 100 from the user device.

The aggregation module upon execution by the processor can aggregate information from external databases and servers, such as travel information. The aggregation module can connect with third-party databases and servers 200 through the network 180 for downloading data. The AI module upon execution by the processor can learn about the travel preferences of the user. The planning module upon execution by the processor can help plan and execute a trip.

The disclosed system, method, and dashboard can aggregate trip-related information in one location from a variety of sources. Modern travel information and related resources may be spread throughout various websites, emails, applications, etc., and it may be difficult to find and keep track of relevant information during a trip. For example, without limitation, such travel information may include directions, food, entertainment, nightlife, places to visit, things to do, top sights to see, tourist attractions, things for kids, best shopping malls, festivals, and family-friendly events, theaters, hidden gems, nearest supermarkets, sporting events, parks, and recreation, etc. The aggregation module may collect data such as, but not limited to, user-inputted information, reviews, user preferences, travel resources, etc. The disclosed system, method, and dashboard may not bombard the user with information that may be irrelevant to the user. The AI module 160 can learn the requirements of the user based on user inputs, habits, preferences, and the like. The AI module can prepare a personalized AI model for the user, and the aggregation module can use the personalized AI model to analyze the data and present information and resources that may be relevant to the user. The aggregation module, using the personalized AI model can predict the requirements of the user and suggest relevant information on time.

The disclosed interface module may generate an overlay screen that can overlay over any other application, such as hovering over a display of the user device and providing quick information to the user. For example, the overlay screen can be visible while using any application on the user device. The overlay screen can be readily accessible for both providing output and receiving input while using any other application or resource on the user device. The overlay screen can present a host of information on the display, such as user preferences, user data, location data, reviews, weather, local time, etc., and may be personalized based on a user's demographic. Demographics may include, for example, without limitation, age, sex, employment, marital status, family size, number of children, frequency of travel, the preferred method of traveling, Green vs. non-green preferences, comfort with technology, languages spoken, favorite foods, entertainment preferences, hotel-style preferences in levels of luxury and comfort to their individual style of travel, the purpose of travel, length of stay and destination selections, amount of distance traveled, etc. The overlay screen can provide quick tips and suggestions to the user, wherein such tips and suggestions can be obtained from the aggregated data. The overlay screen can have transparency such that not to obscure the content of an underlying screen. Moreover, the overlay screen may remain visible and inactive while the user interacts with the underlying application. For example, the underlying screen can receive touch input from a visible but inactive overlay screen above the underlying screen. Certain gestures can be used to activate the overlay screen, such gestures can be touch inputs or voice commands. For example, data can drag and drop from an underlying screen to the overlay screen using two-finger touch. Similarly, shaking the user device in a predefined manner may activate or deactivate the overlay screen. The user can also hide and unhide the overlay screen.

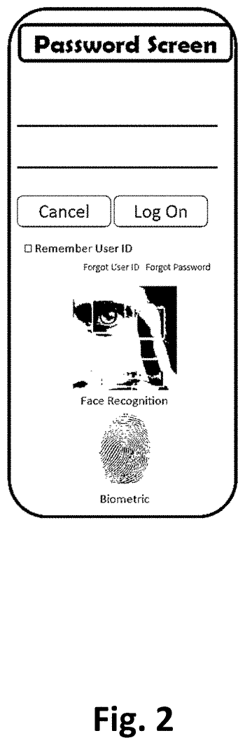

Referring to FIG. 2, which shows a screen of the disclosed interface, which is a login screen. The access of the user to the disclosed system can be secured by generating a username and password for the user. Besides, alphanumeric passwords, the disclosed system can also allow biometric data, such as fingerprints for authentication. The user may enter a username and password into the username field and password field, respectively. To cancel input, the user may use the cancel button, or to submit the username and password, the user may use the logon button. The login screen may optionally remember one or more user credentials if the option of “remember user-id” is toggled on. If the user has forgotten one or more of the user's credentials, the user may use the “forgot user ID” button and/or “forgot password” button to retrieve or reset their credentials. Alternative log-in means may be used instead of a username and password, such as, but not limited to, facial recognition, fingerprint scanner, etc. As will be appreciated by one skilled in the art, additional log-in means may be used to access the disclosed system and may not be limited to the aforementioned means. For example, without limitation, a pin, a pattern, etc. can be used without departing from the scope of the present invention.

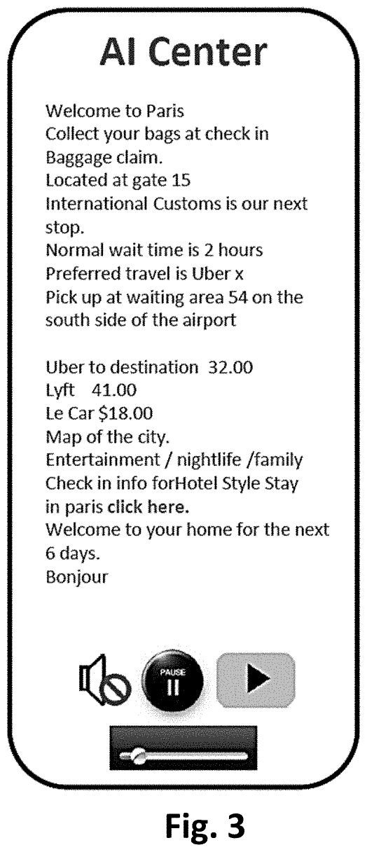

Referring to FIG. 3 which shows an artificial intelligence (AI) screen, in accordance with an embodiment of the present invention. The planning module, using the personalized AI module may display the trip information in an organized, brief, and orderly manner to the user. The planning module may act as a travel companion of the user providing the trip information wherein required. The screen in FIG. 3 shows the city, baggage claim location, average wait times, rideshare availability, maps, costs, entertainment options, etc. In addition to displaying the information to the user, alternative output means may be used to transmit relevant information to the user, including, but not limited to, video, audio, etc. To mute any audio from the screen, the mute button may be used. Additionally, to pause and play audio playback, a pause button, and a play button may be used. The screen may also include volume control to adjust the volume of audio playback.

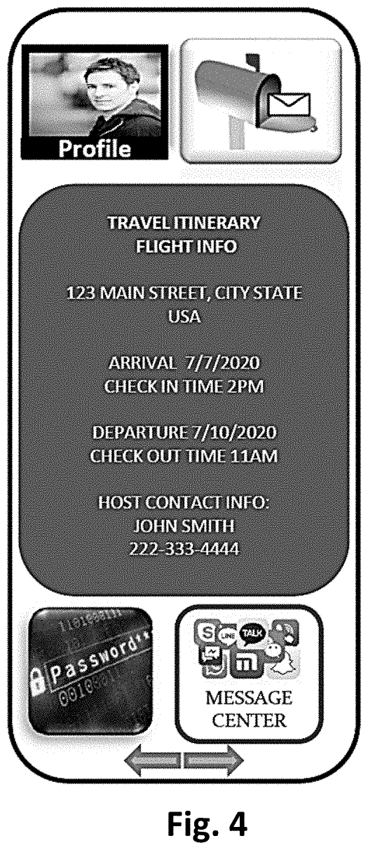

FIG. 4 illustrates a personal travel information screen, in accordance with an aspect of the present invention. A personal travel information screen may be used to display various information related to the user. The user profile may include user profile information, such as, but not limited to, username, password, address, phone number, name, etc. Additionally, the user may update or delete user information through the user profile. Email may be linked to the user's email and may be used, for example, without limitation, to filter out travel-related emails and itineraries. Travel itineraries may use aggregated data to display relevant travel information to the user, such as, without limitation, flight information, accommodation information, transportation information, etc. A password button may be used to update the user's password. The message center may be a centralized location for the user's messaging apps. Included in each of the following screens may be the back button and forward button to navigate between the screens. Alternative means of navigation may also be used, such as, without limitation, swiping, etc.

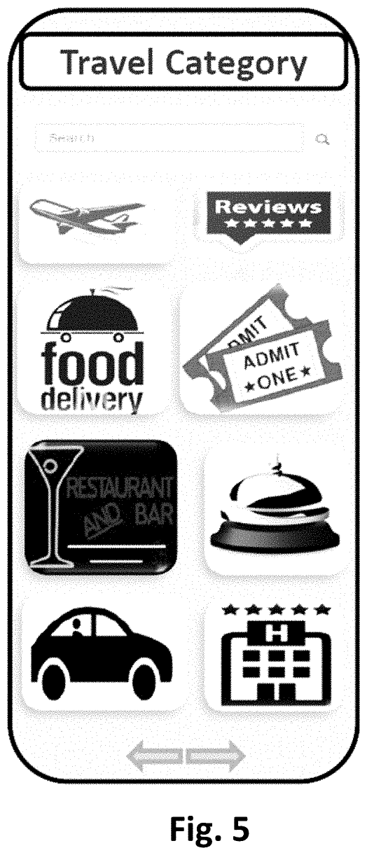

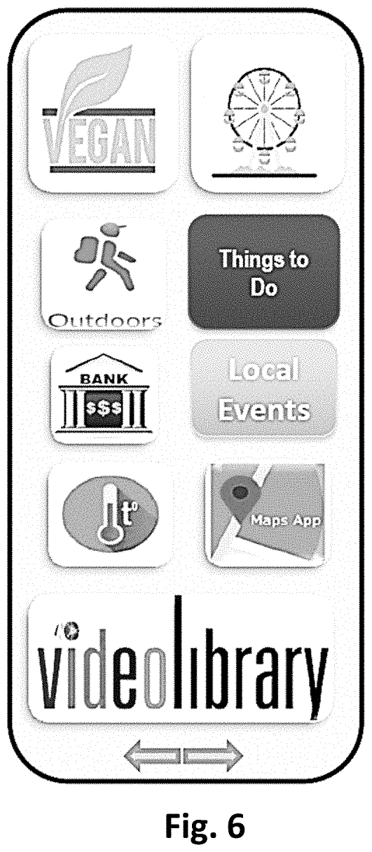

FIGS. 5 and 6 illustrate exemplary travel category screens, in accordance with an embodiment of the present invention. Travel category screens may include a variety of travel-related applications or widgets accessible in one central location. The search bar may be used to find new applications or widgets to add to the travel category screens. Airlines may include information related to airlines, including, for example, without limitation, flight itineraries, ticket purchases, airline flight policies, etc. Reviews may include reviews related to travel-related activities. Food delivery may provide a user with food delivery options near the user's location. Movies may display information related to local theaters, including, but not limited to, showtimes, distances, prices, etc. Restaurants may include information related to local restaurants and bars. Concierge services may include concierge activities such as, without limitation, booking hotel rooms, making restaurant reservations, etc. Rideshare may include information related to local rideshare options. Hotels may include hotel information, such as, but not limited to, check-in/check-out times, hotel location, hotel pricing, etc. Vegan options may include restaurants and grocery stores with vegan options. Amusement parks may include information related to local amusement parks and fairs, such as, without limitation, ticket prices, ride availability/wait times, user reviews, maps, etc. Hiking may display local hiking trails and information about other outdoor activities. Things to do may display miscellaneous events and landmarks in the local area. Banks may include locations for local banks and may redirect a user to applications or websites related to banks. Local events may include information related to local events. The weather may include information about the local weather, as well as weather forecasts. Maps may include a map of the local area and offer directions to destinations throughout a local area. The video library may include videos related to the local area.

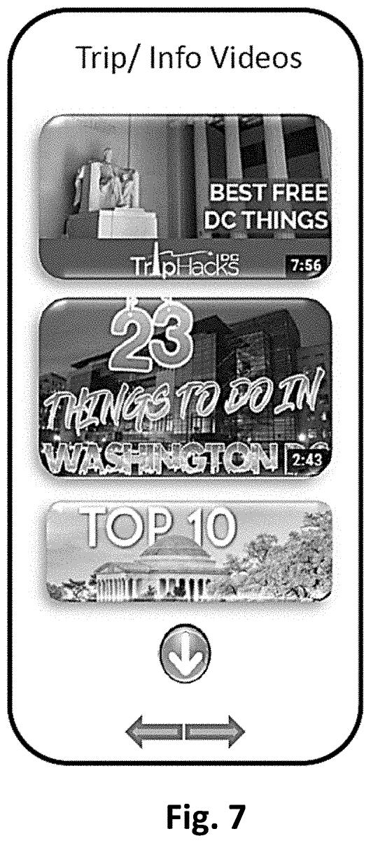

FIG. 7 illustrates an exemplary travel video screen, in accordance with an embodiment of the present invention. Travel videos related to the local area may be aggregated using artificial intelligence and may be based on, for example, without limitation, user information, reviews, weather, etc. Videos may show relevant thumbnails and may show travel information for destinations in the local area.

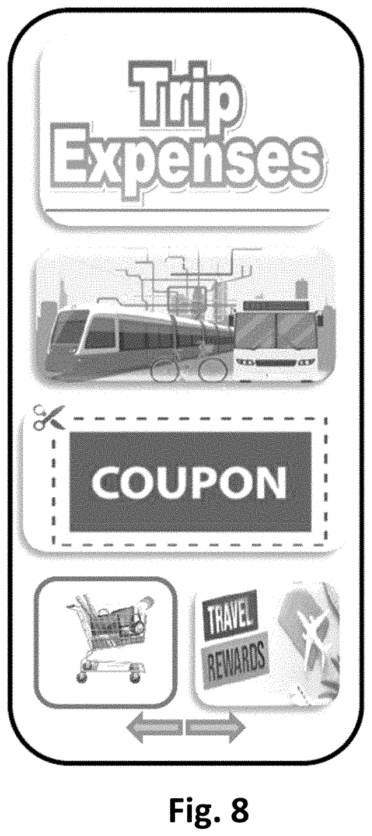

FIG. 8 illustrates an exemplary travel resources screen, in accordance with an embodiment of the present invention. Travel resources may include, for example, without limitation, trip expenses, transit information, coupons, grocery information, travel rewards, etc. The disclosed system can keep a track of expenses with minimum input from the user. Besides digital payment, the system can analyze nearby sounds to determine payments in cash, thus tracking both digital and physical payments.

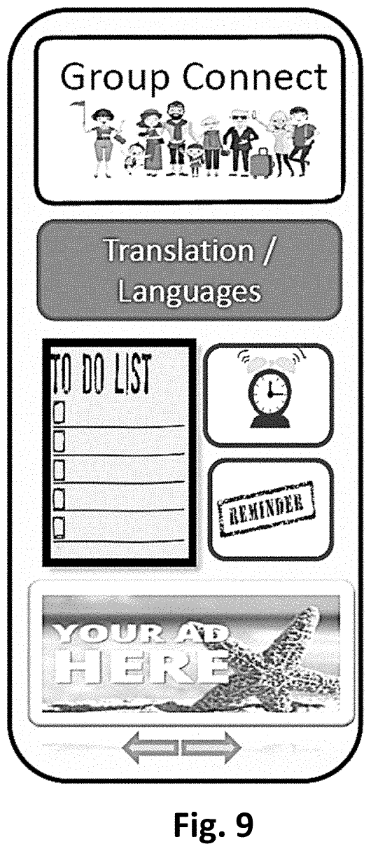

FIG. 9 illustrates an exemplary miscellaneous resources screen, in accordance with an embodiment of the present invention. Group connect may include resources to connect to local groups for specific activities within a locale. The translation may be used to translate between various languages. To-do list may be used to track activities and events to do in an area. Alarms may be used to set alarms for times within an area. Reminders may include user-set and AI-generated reminders for the user. The advertisement may be an advertisement to the user.

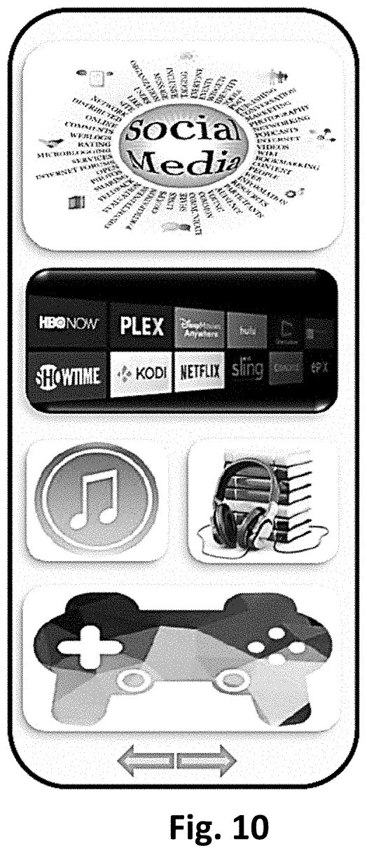

FIG. 10 illustrates an exemplary digital entertainment screen, in accordance with an embodiment of the present invention. Social media may be a central location for social media applications and websites. Streaming services may include a user's streaming services in one location. Music may include music streaming services and locally downloaded audio files. Audio books may include audio books. Games may include games.

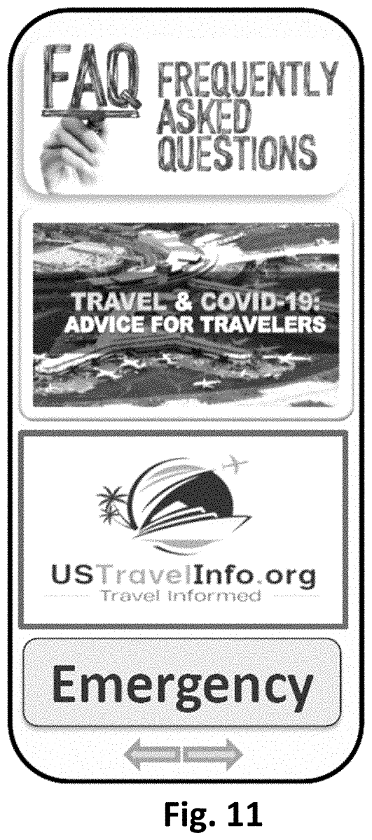

FIG. 11 illustrates an exemplary safety information screen, in accordance with an embodiment of the present invention. Emergency information may include, for example, without limitation, frequently asked questions (FAQ), pandemic/disaster information, travel information, emergency services, etc.

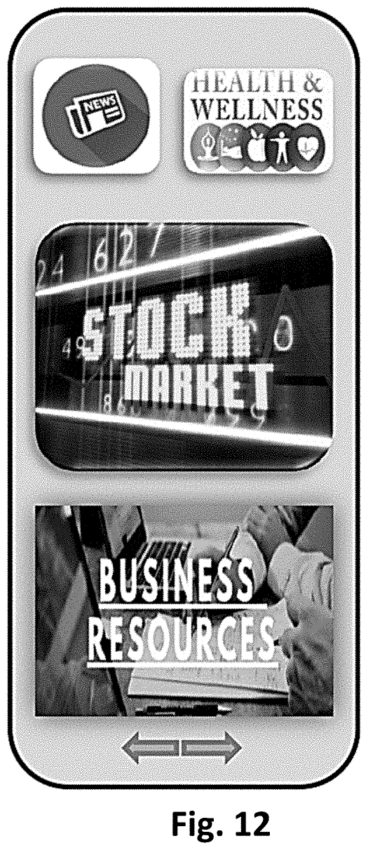

FIG. 12 illustrates an exemplary local information screen, in accordance with an embodiment of the present invention. Local information may include, for example, without limitation, news, health and wellness, stock market, business resources, etc.

As will be appreciated by one skilled in the art, the screens shown in FIGS. 2-12 may include alternative applications, widgets, information, etc. relevant to the user, and may not be limited to the figures shown above. Additionally, additional screens may be used depending on a user's specific needs. Artificial intelligence may be used to suggest screens, apps, modules, widgets, etc. include within the dashboard to the user and may be used to organize the screens, apps, modules, widgets, etc. to be easily accessible by the user.

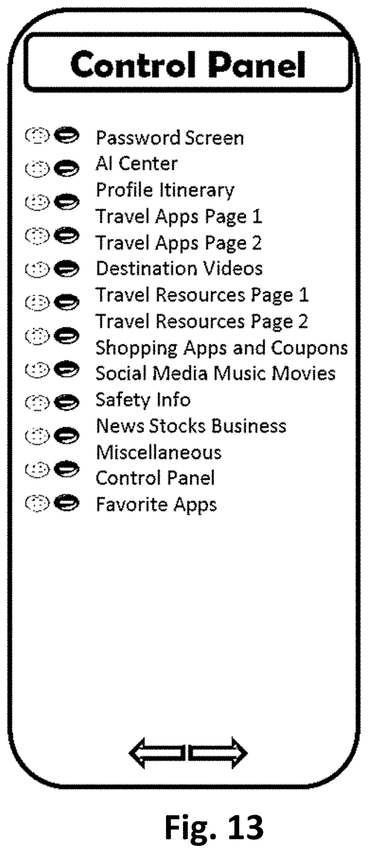

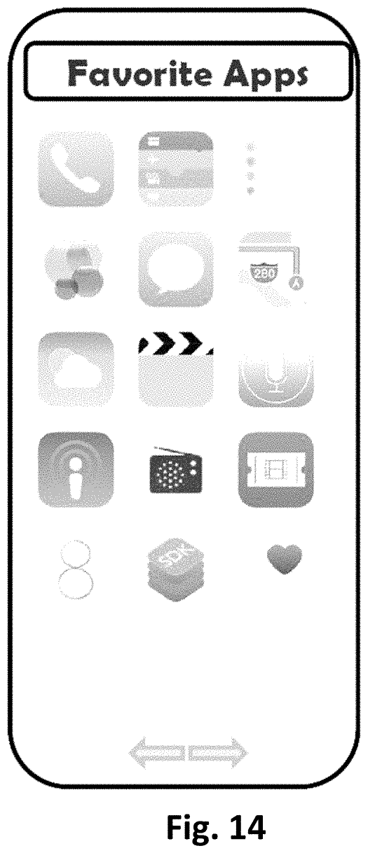

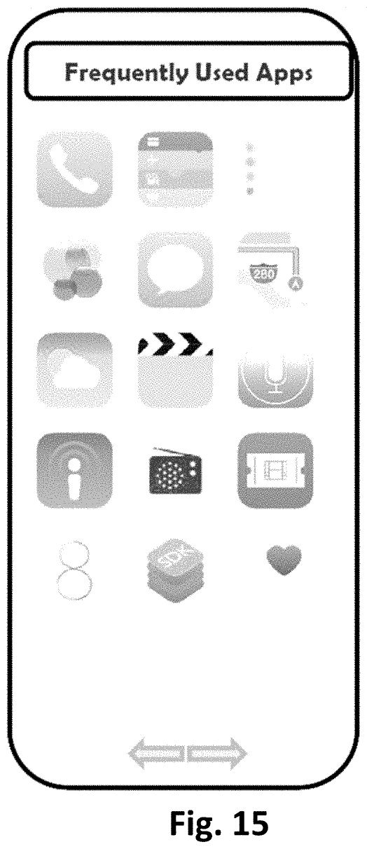

Referring to FIG. 13 which shows a control panel screen that may be used to input preferences, customization, add and remove screens, add or remove third-party apps, and the like. FIG. 14 shows the favorite apps screen that may be used to display a variety of different user-selected favorited applications in one location. FIG. 15 shows the frequently used apps screen which may show a pre-set number of frequently used applications to a user.

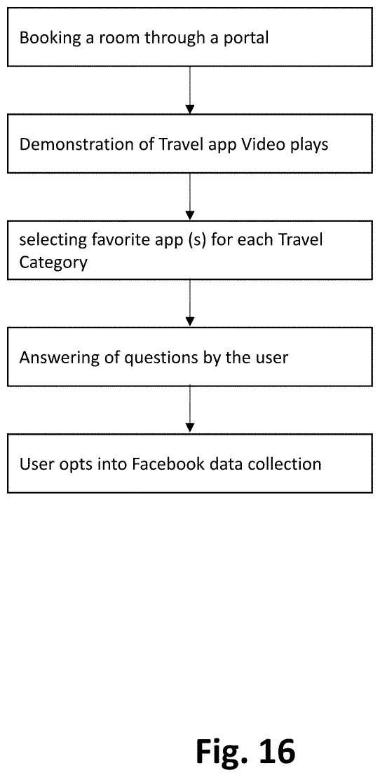

Referring to FIG. 16 which is a flowchart illustrating an exemplary embodiment of the present invention. The first step takes place when a user reserves a stay at the destination place, such as booking a room in a hotel. The user can then provide his preferences using an interface of the disclosed system. The user can select a pre-determined number of apps from each category, such as the three apps that can be selected for each category. The categories include but are not limited to Airlines, Transportation, Food Delivery, Entertainment, social media, Music Apps, Movie Apps, Book Apps, Track Expenses, Maps, Travel Reward Programs, Games, Coupon Apps, Demographic Data is opted in from Facebook. In certain implementations, the user can answer a questionnaire to provide demographics include but are not limited to, age, sex, employment, marital status, family size, number of children, frequency of travel, the preferred method of traveling, Green vs. non-green preferences, comfort with technology, languages spoken, favorite foods, entertainment preferences, hotel-style preferences in levels of luxury and comfort to their style of travel, the purpose of travel, length of stay and destination selections and amount distance of travel. Additional updates to the app will create even more specific personalized customization of the app and the data it presents and aggregates.

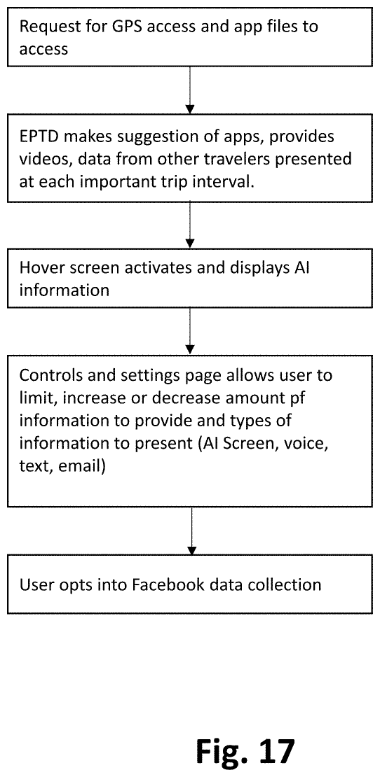

Referring to FIG. 17 which illustrates the steps of the aggregation module and the planning module. The disclosed aggregation module can track any information and communication related to the trip, such as emails, websites, calendars, and the like. This information is stored for the day of travel which may be in a day, a week, or a year. The planning module can start acting as a travel companion a few hours before the date of travel, such as before 24 hours. The planning module will begin to work the day before by introducing itself to the user by email and beginning to work on the morning of travel. The planning module has starting settings and controls on the bare minimum of information to present to the user which include displaying the travel itinerary, flight information, security codes for entering short-term rental, and important telephone numbers. The purpose of the planning module is to display valuable content that will enhance the user's travel experience before during and after their travel begins. The default arrangement, number of pages, direction of the display, categories to display, and default selection of apps and programs of the planning module can be predefined and can be customized as and when desired. Users can enable and disable some or all of the default selections. The disclosed system can function as a travel companion with a valuable dashboard for the user. The system may track the position of the user, about the user, and can make suggestions including offering apps from a personalized library of apps for a variety of travel-related purposes based on the geographical location during each part of your travel including waking up the day of the journey to arriving home at the end of it. The unique overlay screen can hover above all apps while the disclosed system is active. A digital display of all “spoken” suggestions reads across the display page. This information continues to scroll. The display coincides with spoken messages from the Dashboard voice which can be customized to be a male, female, or robot voice in different languages and dialects from around the world. It provides information in multiple ways: speaking to the user, digital display of all “spoken” suggestions read across the display page, pop-up messages, email, and texts. Trips require different information at separate times. For example, the below information can be considered important by the system and can be displayed on the overlay screen.

TABLE 1
The information displayed on the overlay screen

| Day of | Wakeup Destination information |
|---|---|
| Travel | Flight Information |
| Transportation | Share Vehicles. Data on which choices others |
| to Airport | have made to travel to airport. |
| | Example 85% of people take Uber. 12% Lyft, 1% |
| | Via Music Apps and Music/Video Suggestions |
| Departure | Updated Gate Information |
| Airport | Food and Shopping Recommendations |
| | Updates on Covid/Health Requirements |
| | Government restrictions and warnings |
| | Entertainment App suggestions |
| | (Books/Music/Movies etc.) |
| Arrival | Frequently Asked Question |
| airport | Updates on Covid/Health Requirements |
| | Food/Shopping |
| Transportation | Videos Welcome to Destination |
| to travel stay | Travel Tips and Suggestions: Video Choices |
| | Top ten things to do |
| | Top ten things to avoid |
| | Topics from YouTube relevant to this destination |
| | Entertainment App suggestions |
| | (Books/Music/Movies etc.) |
| Destination | Apps to use on trip: Expenses, |
| (Hotel/Airbnb) | Safety Related Info, Food, Things to Do, |
| | Live, Shopping, Local Merchants, |
| | Coupons, Bars, Nightlife etc. |
| Return Trip | Share Vehicles. Data on which choices others |
| to Airport | have made to travel to airport. |
| | Example 85% of people take Uber. 12% Lyft, 1% |
| | Via Music Apps and Music/Video Suggestions |
| Departure | Updated Gate Information |
| Airport | Food and Shopping Recommendations |
| | Updates on Covid/Health Requirements |
| | Government restrictions and warnings |
| | Entertainment App suggestions |
| | (Books/Music/Movies etc.) |
| Arrival | Frequently Asked Question |
| airport | Updates on Covid/Health Requirements |
| | Food/Shopping |
| Transportation | Share Vehicles. Data on which choices others |
| from Airport | have made to travel to airport. |
| | Example 85% of people take Uber. 12% Lyft, 1% |
| | Via Music Apps and Music/Video Suggestions |

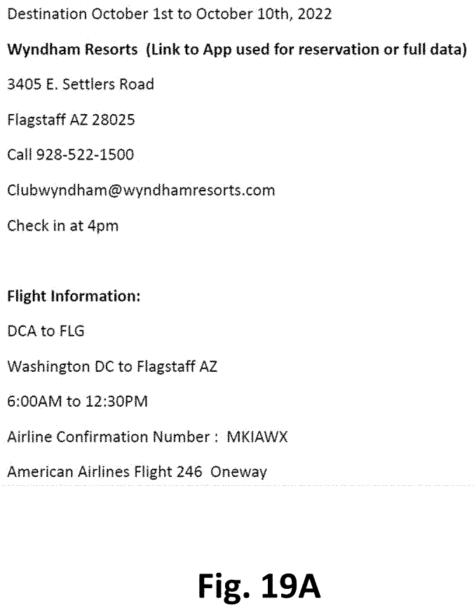

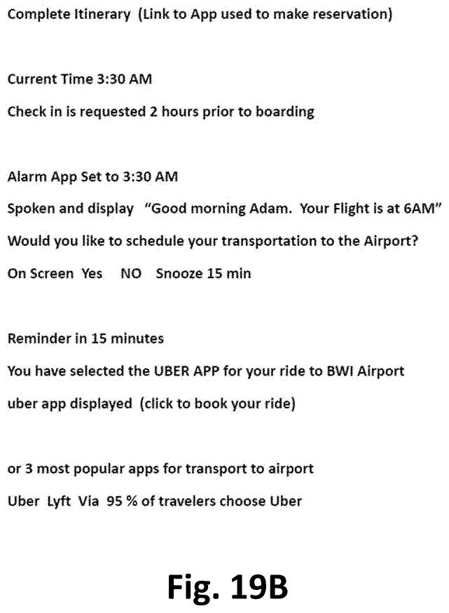

For example, on the first day of the trip, the disclosed system can display the destination information and transport information on the overlay screen, as shown in FIGS. 19A and 19B.

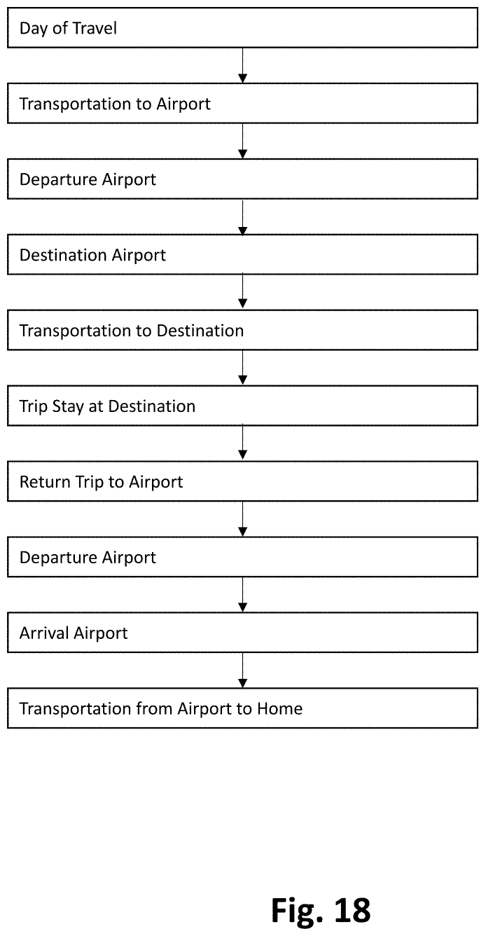

The user can scroll through the overlay screen using certain predefined gestures. Alternatively, the overlay screen can scroll automatically at a predefined rate. The planning module may also output the information as audio, wherein the display of information on the overlay screen and the audio can both be in sync. The audio can be customized to be a male, female, or robot voice in different languages and dialects from around the world. The disclosed system can be adapted to share data with any third-party database or travel platform. This includes, but is not limited to, home-sharing apps, hotel apps, concierge apps, map apps, booking apps, local or long-distance travel planning apps, or as a stand-alone app. The disclosed system can aggregate relevant data from the travel apps, the user agrees to connect, including airline reservation information, hotel information, time of travel, and anything relevant to the user's trip. Using all the information, the disclosed system can act as a travel companion guiding the user during the travel, such as suggestions on how to travel, things to do, places to go, apps to install, and anything related to their travel. The system can suggest videos and content that are relevant to their demographic and destination which may be sourced from the internet, current location, or from apps the user authorizes us to pull content from such as YouTube, Vimeo or Facebook, or others. In addition to self-designed categories of content, the disclosed can use artificial intelligence (AI) to anticipate what the user wants to view and discover. The system can use AI to learn from user decisions throughout their travel from selections of location, quality, spending patterns, purchases, value decisions, and other variables that enable the system to customize the content and categories that are displayed which are personalized to the user's demographic. Most importantly the disclosed system can function as an AI data aggregator and communicator to the user. It pulls data from many sources to provide real-time suggestions to the user to answer questions, provide suggestions, and advertises things of value to the user through voice and text. The disclosed dashboard can organize personal choices related to travel, to anticipate things that would be of interest to the user and the system uses local GPS to notify and advertise resources, products, and services that the user may desire. This system is particularly advantageous in that it can be expanded from a single screen to multiple screens. Like other screen organizing systems, groups of apps can pop up for the user to choose from. It is unique in its ability to anticipate what a user needs based on real-time GPS data during the trip starting at a particular time (which the user can set) and ending on a certain date that the user can set. This system is unique in its ability to use its database to present choices to the user based on the popularity of apps used at various times along a trip to a destination and back. The system could have a face of a robot or a travel assistant female or male or an avatar. This could appear to be talking on the screen instead of words being used. The AI screen could have multiple screens so an app could pop up at the bottom of the screen while the app text is shown at the top. There could be side panels, top panels, and bottom panels with buttons with titles like: make a suggestion, favorites, itinerary, next, and reverse. Settings would allow the user to add, delete, slow down or speed up the AI. Users could decline the sharing of their data. The user could join points programs. The user could increase their involvement and earn points or money for being a paid critique of the process. Like being a secret shopper. They could be evaluating all the travel services from airlines to hotels, to the restaurant to excursions. FIG. 18 shows an implementation of the planning module that can work as a travel companion from the start of the trip i.e., from the date of travel, and through various stages of the travel as shown in FIG. 18, and up to when the user returns home.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. A method for guiding an individual on a trip, the method implemented within a system comprising a processor and memory, the method comprising the steps of:
learning, by an AI module implemented within the system and upon execution by the processor, travel-related preferences of a user;
extracting, by an aggregation module implemented within the system and upon execution by the processor, travel-related data not hosted on the system;
determining, by the aggregation module, from the travel-related data, relevant information based on the travel-related preferences; and
presenting, by a planning module implemented within the system and upon execution by the processor, the relevant information on a user device.

2. The method according to claim 1, wherein the method further comprises the steps of:
determining, by the planning module, a current location of the user device; and
presenting, by the planning module, a portion of the relevant information that is related to the current location.

3. The method according to claim 1, wherein the method further comprises the steps of:
presenting, by an interface module implemented within the system and upon execution by the processor, a list of travel-related categories on the user device, wherein each category of the list of travel-related categories comprises a plurality of related applications;
receiving, by the interface module, a selection of a predetermined number of related applications from the plurality of related applications in the each category; and
presenting, by the interface module, the selected applications category-wise.

4. The method according to claim 3, wherein the method further comprises the steps of:
tracking usage of application on the user device; and
presenting, by the interface module, a screen that has a list of frequently used applications based on the usage.

5. The method according to claim 2, wherein the method further comprises the steps of:
presenting, by an interface module implemented within the system and upon execution by the processor, an overlay screen on the user device, wherein the portion of the relevant information is presented on the overlay screen, wherein the overlay screen is configured to switch between a visible and inactive state and a visible and active state.

6. A system for guiding an individual on a trip, the system comprising a processor and memory, the system configured to implement a method comprising the steps of:
learning, by an AI module implemented within the system and upon execution by the processor, travel-related preferences of a user;
extracting, by an aggregation module implemented within the system and upon execution by the processor, travel-related data not hosted on the system;
determining, by the aggregation module, from the travel-related data, relevant information based on the travel-related preferences; and
presenting, by a planning module implemented within the system and upon execution by the processor, the relevant information on a user device.

7. The system according to claim 6, wherein the system is further configured to implement the steps of:
determining, by the planning module, a current location of the user device; and
presenting, by the planning module, a portion of the relevant information that is related to the current location.

8. The system according to claim 6, wherein the system is further configured to implement the steps of:
presenting, by an interface module implemented within the system and upon execution by the processor, a list of travel-related categories on the user device, wherein each category of the list of travel-related categories comprises a plurality of related applications;
receiving, by the interface module, a selection of a predetermined number of related applications from the plurality of related applications in the each category; and
presenting, by the interface module, the selected applications category-wise.

9. The system according to claim 8, wherein the system is further configured to implement the steps of:
tracking usage of application on the user device; and
presenting, by the interface module, a screen that has a list of frequently used applications based on the usage.

10. The system according to claim 7, wherein the system is further configured to implement the steps of:
presenting, by an interface module implemented within the system and upon execution by the processor, an overlay screen on the user device, wherein the portion of the relevant information is presented on the overlay screen, wherein the overlay screen is configured to switch between a visible and inactive state and a visible and active state.
